(19) United States
(12) Patent Application Publication
(10) Pub. No.: US 2012/0329446 A1
(43) Pub. Date: Dec. 27, 2012

(54) Device Control System via a Mobile Radio Telephone

(75) Inventor: Bernd Dietel, Horgen (CH)

(73) Assignee: ARMATIX INVEST GMBH, Zurich (CH)

(21) Appl. No.: 13/508,405

(22) PCT Filed: Oct. 28, 2010
(86) PCT No.: PCT/EP10/06593

§ 371 Date: Sep. 14, 2012

(30) Foreign Application Priority Data
Nov. 6, 2009 (DE) 10 2009 052 194.1

(51) Int. Cl. H04W 4/00

(52) U.S. Cl. 455/420

(57) ABSTRACT

The disclosure relates to a mobile radio telephone, a receiver, a system and a method for the remote control of a device to be controlled by means of the mobile telephone designed to communicate according to a predetermined mobile radio standard, in a mobile radio network operating according to said predetermined mobile radio standard, to generate an out-put signal comprising at least one control command for the device to be controlled, and to transmit the output signal directly to the device to be controlled.

### FIELD OF THE INVENTION

The present invention generally relates to the radio-based control of devices and, in particular, to the control of a device by means of a cellular phone.

### BACKGROUND OF THE INVENTION

Remote control of devices, in particular, in the field of building services (e.g. control of heating systems, air-conditioning systems, etc.) is well known. For example, radio remote controls with, for example, a transmission range restricted to a building as well as cellular phones, which transmit messages including control commands to a device to be controlled via the respective mobile communications network, are used for this purpose. In known approaches for remote control via cellular phone, for example, so-called SMS services and messages, respectively, are used.

It is disadvantageous here that the cellular phone has to be registered or logged with the respective mobile communications network in order to be able to transmit a message compliant with the mobile communications network standard. If the cellular phone is not registered with or has no connection to the mobile communications network (e.g. within a building), it is not possible to transmit messages and thus to perform remote control.

### OBJECT OF THE INVENTION

It is the object of the present invention to provide measures and means for improving the remote control of optional devices via cellular phone.

### SUMMARY OF THE INVENTION

In order to achieve this object, the present invention provides cellular phones, receivers, systems and methods according to the independent claims. Preferred embodiments are defined in the dependent claims.

In particular, the present invention provides a cellular phone for the remote control of a device to be controlled, wherein the cellular phone is adapted to communicate according to a predetermined mobile communications standard in a mobile communications network operating in accordance with the predetermined mobile communications standard, to generate a radio signal as an output signal, said radio signal comprising at least one control command for the device to be controlled, and to transmit the radio signal within a frequency range provided for the mobile communications network directly to a receiver associated with the device to be controlled.

Examples of possible mobile communications networks include networks operating in accordance with the CDMA, GSM, UMTS and/or LTE standard and utilizing, for example, the frequency ranges 880-915 MHz (GSM 900), 1710-1785 MHz (GSM 1800), 1920-1980 MHz (UMTS) used for the so-called uplink, i.e. the connection from the cellular phone to the mobile communications network.

In other words, a cellular phone can be used for the remote control of a device—regardless of whether it is registered/logged with its mobile communications network—according to such embodiments of the present invention. The cellular phone comprises a transmitting means by means of which radio signals can be transmitted according to the mobile communications standard via the mobile communications network. However, such radio signals are not used for remote control according to the invention. The cellular phone is capable of transmitting radio signals even if not registered with the mobile communications network, comparable to a situation where the cellular phone is turned on and tries to establish a connection to the mobile communications network. However, the radio signal is sent directly to the receiver of the device to be controlled according to the invention, i.e. precisely not via the mobile communications network or components thereof, such as e.g. base stations. Nevertheless, the radio signal may comply with the mobile communications standard. This allows the use of, for example, messages also used in the mobile communications network, such as e.g. SMS, MMS, etc.

The approach according to the invention enables unmodified use of the radio signal generating components of the cellular phone. It may merely be required to provide the radio signal with a “content” which is understood as a control command for the device to be controlled. It may also be required to provide a mode of operation of the cellular phone in which the cellular phone, without being registered with the mobile communications network or without having a proper connection thereto, is able to generate and transmit the radio signal comprising the at least one control command.

Preferably, the radio signal is adapted to generate the radio signal in form of a radio signal not compliant with the mobile communications standard which is nevertheless transmitted within the frequency range provided for the mobile communications network. In such embodiments, the cellular phone can be operated, for example, in a mode of operation in which the turned-on cellular phone does not try to establish a communication link with the mobile communications network or register itself therewith; such a mode of operation is also referred to as “off-line” mode.

Preferably, radio signals comprising various control commands are stored in the cellular phone and may be selected by means of corresponding user inputs and transmitted to the receiver of the device to be controlled.

Furthermore, the present invention provides a cellular phone for the remote control of a device to be controlled, wherein the cellular phone is adapted to communicate according to a predetermined mobile communications standard in a mobile communications network operating in accordance with the predetermined mobile communications standard, and comprises audio signal generating and outputting devices which are adapted to generate an audio signal as an output signal comprising at least one control command for the device to be controlled and to output said signal to a receiver associated with the device to be controlled.

In other words, a cellular phone can be used for the remote control of a device—regardless of whether it is registered/logged with its mobile communications network—also in accordance with such embodiments of the present invention. Also in this case, the cellular phone can be used without modification (or, if so, only with minimal, preferably software-specific modification and/or supplement), specifically, of its audio functionality. Cellular phones are generally provided with hardware and/or software means enabling storage and reproduction of stored audio data. One example of this are so-called “MP3 players” integrated into cellular phones. For reproduction/output of audio information, generally the loudspeaker of the cellular phone is employed which is otherwise used for speech output and call signaling (“phone ringing”) when making a call.

Preferably, audio files comprising various control commands in form of audio signals are stored in the cellular phone and can be selected by corresponding user inputs.

The selected audio signal may then be used by itself or embedded in another audio signal as an output signal.

The audio signal can be output as an audible audio signal, for example, in the manner of MFV (Multi Frequency Method), DTMF (Dual Tone Multi Frequency) signals etc.

In embodiments according to the invention, the cellular phone may comprise hardware and/or software implemented functionality for generating the output signal. Also in such embodiments, it is not required to modify components of the cellular phone provided for radio signal transmission, such as e.g. the transmitter and/or audio signal generating and outputting devices thereof. In order to implement this kind of functionality in a software-based manner, for example, software programs, so-called plug-ins, and software applications, can be used. The hardware-based implementation may be preferred, for example, in cellular phones in which software adaptation is not possible and can be achieved, for example, by means of a module capable of communicating with the cellular phone via an interface thereof and controlling the same at least in part, if applicable, for example, in order to utilize the transmitting means thereof for transmission of the radio signal and/or the audio signal generating and outputting devices thereof.

The cellular phone may be adapted to receive a response of a transmitter associated with the device to be controlled, which response indicates, for example, whether the output signal of the cellular phone has been received by the receiver (e.g. in form of an “acknowledgement of receipt” or a “confirmation signal”), that the at least one control command has been transmitted to the device to be controlled, and/or that the device to be controlled has been controlled in correspondence with the at least one control command.

The receiver and the transmitter can be designed separately or integrated in a structurally consistent manner.

Regardless of whether the output signal is a radio signal or an audio signal, the cellular phone may be adapted to receive a response of the transmitter in form of a radio signal compliant with the mobile communications standard which is transmitted from the transmitter to the cellular phone via the mobile communications network.

Supplementary or alternatively, the cellular phone may be adapted to receive a response of the transmitter in form of radio signal not compliant with the mobile communications standard, which signal is transmitted directly, i.e. not via the mobile communications network, from the transmitter to the cellular phone. For this purpose, the cellular phone can employ its conventional receiving means which is usually used for communication in the mobile communications network. In this connection, the cellular phone does not need to be registered or logged with the mobile communications network. Rather, cellular phones, even if not registered or logged with the mobile communications network, are capable of receiving radio signals within the predetermined frequency range. On principle, the cellular phone is capable of receiving radio signals within the predetermined frequency range when turned on. One example of this are situations where the cellular phone (e.g. after turning on or after an interruption of the connection to mobile communications network) tries (again) to establish a connection to mobile communications network.

Moreover, the cellular phone may alternatively or supplementary be adapted to receive a response of the transmitter in form of an audio signal. For example, the microphone of cellular phone, which usually records speech during a call, can be used for this purpose.

Preferably, the cellular phone comprises hardware and/or software-specific functionality or functionalities for receiving and processing responses of the transmitter.

The present invention further provides a receiver for a device which can be controlled by remote control, wherein remote control is provided by means of a cellular phone which is adapted to communicate according to a predetermined mobile communications standard in a mobile communications network operating in accordance with the predetermined mobile communications standard, and to generate an output signal in form of a radio signal, comprising at least one control command for the device to be controlled, within a predetermined frequency range provided for the mobile communications network, wherein the receiver is adapted to receive the radio signal directly and to provide the device to be controlled with the at least one control command.

Preferably, the receiver processes the radio signal at least to such an extent that the at least one control command is obtained/extracted/retrieved.

The receiver may comprise a receiving module, receiving chipset and the like, capable of receiving radio signals within the predetermined frequency range. It is not required that the receiver operates according to the mobile communications standard (e.g. CDMA, CDMA2000, GMS, UMTS, LTE, etc.), however, it may also be configured to receive and process radio signals compliant with the mobile communications standard in order to retrieve the at least one control command and transmit it to the device to be controlled.

Preferably, the receiver is adapted to receive radio signals and to pass the at least one control command on to the device to be controlled, which radio signals are not compliant with the mobile communications standard. In such embodiments, receiving components compliant with the mobile communications standard may be dispensed with in the receiver; however, the receiver may also comprise receiving components compliant with the mobile communications standard, for example, in order to receive radio signals of different cellular phones transmitting radio signals compliant with the mobile communications standard and radio signals not compliant with the mobile communications standard.

Furthermore, the present invention provides a receiver for a device which can be controlled by remote control, wherein remote control is provided by means of a cellular phone which is adapted to communicate according to a predetermined mobile communications standard in a mobile communications network operating in accordance with the predetermined mobile communications standard, and to generate and transmit an output signal in form of an audio signal comprising at least one control command for the device to be controlled, wherein the receiver is adapted to receive the audio signal and to provide the device to be controlled with the at least one control command.

The receiver may be adapted to receive MFV (Multi Frequency Method), DTMF (Dual Tone Multi Frequency) signals etc.

The receiver itself may be adapted to transmit the at least one control command to the device to be controlled without processing which then processes the at least one control command. The receiver may be adapted to extract the at least one control command from the output signal and to process it so that the device to be controlled can be provided with, for example, control signals, control data, control information and/or commands and the like having a form the device is able to “understand” immediately, i.e. substantially without any further processing.

The receiver may be adapted to transmit the control command or control information/signals determined therefrom to the device to be controlled in a wireless and/or wireless manner. For this purpose, the receiver may comprise a transmitting device capable of transmitting the control command or control information determined therefrom within the predetermined or another frequency range.

Moreover, the present invention provides a system for remote control of a device to be controlled, wherein the system comprises a device to be controlled, a receiver according to the invention associated with the device to be controlled, and a cellular phone according to the invention.

Examples of devices to be controlled, inter alia, include:
a firearm,
a door lock, window lock, closing/opening means for doors and/or windows for buildings and/or vehicles,
a locking system,
an alarm system (e.g. for buildings, vehicles, etc.),
a building installation (e.g. sun-blinds, heating, air-conditioning, etc.)
a starting means for starting a vehicle (e.g. remotely controlled starter),
a vehicle means (e.g. air-conditioning, auxiliary heating system, etc.).

The at least one control command may indicate that the safety catch on a firearm is to be engaged and/or disengaged, a lock is to be opened/unlatched and/or closed/latched, a locking system is to be activated and/or deactivated, an alarm system is to be turned on/armed and/or turned off, a heating system is to be set (e.g. with respect to temperature, operating hours, etc.), sun-blinds are to be raised and/or lowered.

The present invention also provides a method for the remote control of a device to be controlled by means of a cellular phone, said method comprising the steps of generating an output signal in form of a radio signal, which comprises at least one control command for the device to be controlled, and transmitting the radio signal within a frequency range provided for the mobile communications network directly to a receiver associated with the device to be controlled by means of said cellular phone which is adapted to communicate according to a predetermined mobile communications standard in a mobile communications network operating in accordance with the predetermined mobile communications standard.

Moreover, the present invention provides a method for the remote control of a device to be controlled by means of a cellular phone, said method comprising the steps of generating an output signal in form of an audio signal, which comprises at least one control command for the device to be controlled, and outputting said signal to a receiver associated with the device to be controlled by means of said cellular phone which is adapted to communicate according to a predetermined mobile communications standard in a mobile communications network operating in accordance with the predetermined mobile communications standard, and which comprises an audio signal generating and outputting device.

The above explanations with respect to all above-mentioned embodiments of the cellular phones, receivers and system apply accordingly here and it is intended, in particular, in methods according to the invention, to provide method steps corresponding to individual, a plurality or all of the above device, receiver and system features in an arbitrary combination.

### BRIEF DESCRIPTION OF THE DRAWINGS

In the following description, it is referred to the accompanying drawings, in which:

FIG. 1 shows a schematic representation of an arrangement according to the invention, and

FIG. 2 shows a schematic representation of a further arrangement according to the invention.

### DESCRIPTION OF PREFERRED EMBODIMENTS

In the following, embodiments of the present invention are described by means of two examples.

For example, the present invention enables to open a door 4, more precisely to unlatch the door lock 6 thereof, by means of a cellular phone 2. The cellular phone 2 is adapted to be used in a mobile communications network 8 operating, for example, according to the GMS standard.

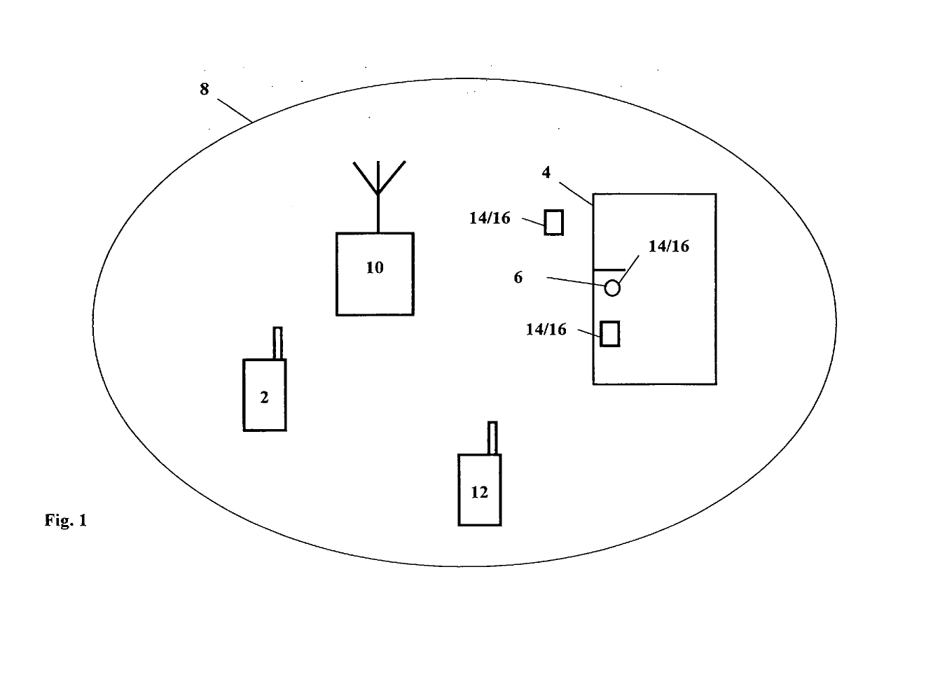

In order to communicate in the mobile communications network 8, the cellular phone 2 registers itself after being turned on. When the cellular phone 2 is registered with the mobile communications network 8 (which is also referred to as logged), the cellular phone 2 is able to communicate within the mobile communications network 8 via one or more base stations (FIG. 1 shows an exemplary base station 10) with other cellular phones (FIG. 1 shows an exemplary cellular phone 12) and other communication devices and systems (not shown), such as e.g. landline phones, the internet, computers, etc. For this purpose, the cellular phone 2 uses radio signals according to the mobile communications standard underlying the mobile communications network, e.g. the GSM standard. The cellular phone 2 transmits such radio signals compliant with the mobile communications standard into the mobile communications network and receives such radio signals via the mobile communications network, for example, from the cellular phone 12. However, registration of the cellular phone 2 with the mobile communications network 8 is not a prerequisite for the remote control described in the following.

For transmission of radio signals compliant with the mobile communications standard, a frequency range predetermined for the mobile communications network 8 is available within which the cellular phone 2 is able to transmit and receive radio signals. Usually, a sub-range of the predetermined frequency range is used for radio signals from the cellular phone to the mobile communications network (“uplink”), while another separate sub-range of the predetermined frequency range is provided for radio signals to the cellular phone (“downlink”).

Accordingly, the cellular phone is adapted to transmit radio signals within the frequency sub-range used for transmission to the mobile communications network and to receive radio signals within the frequency sub-range used for transmission from the mobile communications network. However, this distinction is not made in the following, in order to consider, for example, also mobile communications networks in which the predetermined frequency range is not divided into sub-ranges and the entire predetermined frequency range can be used for transmission by the cellular phone.

The cellular phone 2 is capable of generating and transmitting radio signals for the predetermined frequency range even if not registered with the mobile communications networks 8 and ready to communicate therein.

For controlling the door lock 6, radio signals, which are not as such transmitted within the mobile communications network, are not used but rather radio signals which are merely transmitted within the predetermined frequency range. In other respects, the radio signals may differ at least in part or completely from radio signals compliant with the mobile communications standard.

For controlling the door lock 6, radio signals are generated which each comprise at least one control command corresponding to the desired control of the door lock 6. For example, a radio signal may comprise a control command for unlatching/opening the door lock 6 or a control command for latching/closing the door lock 6.

Control commands can be stored permanently in the cellular phone 2 in order to be read out and embedded into a radio signal on demand (in response to a user input). Control commands can also be stored temporarily, for example, for a predetermined period of time (e.g. for the duration of a stay in a hotel) in order to be able to open and/or close this one door (e.g. the door of a hotel room) during this period.

Control commands may be provided to the cellular phone 2, for example, via a wired connection (e.g. via a data port of the cellular phone) established with the cellular phone 2 and/or via a wireless connection (e.g. via Bluetooth, infrared) and/or using a message (e.g. in form of an SMS, MMS, e-mail, etc.) transmitted to the cellular phone 2 via the mobile communications network. For example, the cellular phone 2 can be provided with a control command for opening a lock of a room door of a hotel when checking in at a hotel, which control command is valid for the period of time for which the hotel room is booked and can be used for opening the door. Since hotel doors usually close/latch themselves when snapping shut, a control command for opening the door may possibly be dispensed with. In doors having a lock which is to be actuated for opening and closing, the cellular phone 2 may be provided with a control command for opening and with a control command for closing, for example, a door lock of a vehicle, a front door, etc. Also in this case, the at least one of the control commands may be temporarily valid.

In the example shown in FIG. 1, the cellular phone 2 generates a radio signal comprising the corresponding control command when the door 4 is to be opened and sends this radio signal directly, i.e. not via the mobile communications network, to the door lock 6. A receiver 14, which is capable of receiving radio signals of the cellular phone within the predetermined frequency range, is associated with the door lock 6.

The receiver 14 can be integrated into the door lock 6 or the door 4 or can be arranged at a position adjacent to the door 4; in FIG. 1, this is illustrated by the various receivers 6, of which individual ones or a plurality can be provided. The use of a plurality of receivers is better suited to ensure that the control command is received, for example, in order to avoid transmission problems due to interferences caused by other radio signals and/or unfavorable positioning of the cellular phone.

A wireless and/or wired connection between the receiver 14 and the door lock 6 or the control thereof (not shown) is provided. The received radio signal is evaluated, processed and the like by the receiver 14 or a device associated therewith in order to retrieve the control command. The extracted control command can then be provided to the control of the door lock 6 directly without further processing or after processing, for example, for obtaining control data and/or information which readily control the door lock 6.

A transmitter 16 can also be associated with the door lock 6 which can be integrated into the door lock 6 or the door 4 or can be arranged at a position adjacent to the door 4; in FIG. 1, this is illustrated by the various transmitters 16, of which individual ones or a plurality can be provided. The use of a plurality of transmitters is better suited to avoid, for example, transmission problems between the transmitter 16 and the cellular phone 2 due to interferences caused by other radio signals and/or unfavorable positioning of the cellular phone.

A wireless and/or wired connection between the transmitter 16 and the door lock 6 or the control thereof (not shown) is provided.

The cellular phone 2 can be informed by the transmitter(s) 16 that the control command has been properly received and implemented, in this case in particular, that the door lock 6 has been unlatched. Such a feedback can be implemented by means of a radio signal transmitted directly from the transmitter 16 to the cellular phone 2 without making a detour via the mobile communications network. On principle, a radio signal provided for this purpose is comparable to the radio signal comprising a control command transmitted by the cellular phone 2; however, said radio signal does not comprise a control command but the feedback to the cellular phone 2. Radio signals compliant with the mobile communications standard and/or audio signals can be employed.

Receiver 14 and transmitter 16 can be provided as a unit, as shown in FIG. 1, or as separate devices as not shown.

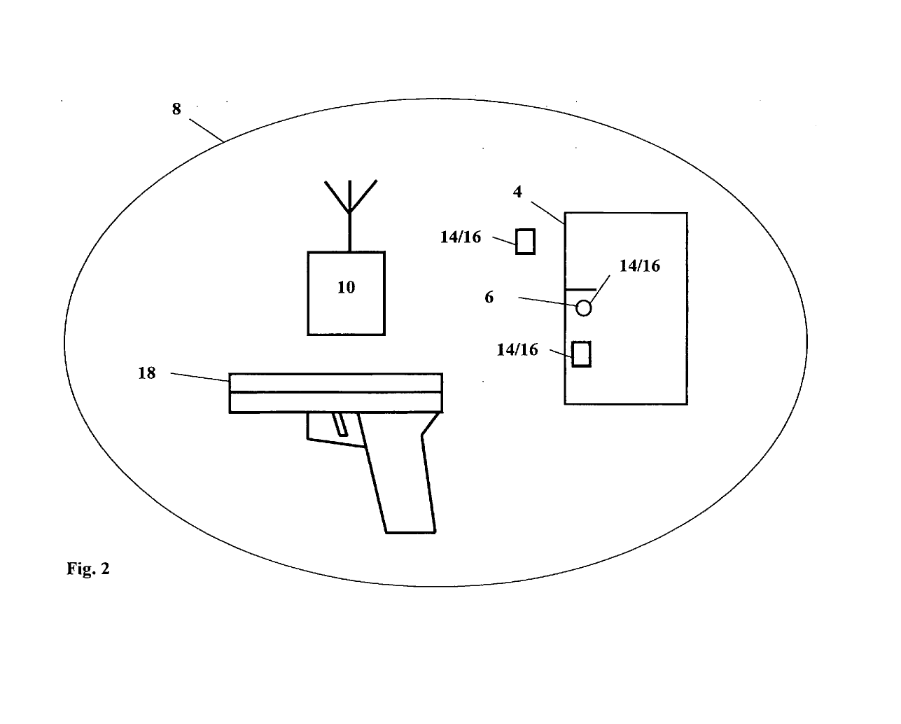

FIG. 2 shows a further possible application wherein a firearm 18 can be controlled by means of the cellular phone 2. For example, the safety catch on a firearm 18 can be engaged and released by means of the cellular phone 2. A repetition of the above explanations, which apply accordingly here, as to the operation of the cellular phone 2 in the communications network is dispensed with here.

For controlling the firearm 18, radio signals, which are not as such transmitted within the mobile communications network, are not used but rather radio signals which are merely transmitted within the predetermined frequency range. In other respects, the radio signals may differ at least in part or completely from radio signals compliant with the mobile communications standard.

For controlling the firearm 18, radio signals are generated which each comprise at least one control command corresponding to the desired control of the firearm 18. For example, a radio signal may comprise a control command for engaging the safety catch on the firearm 18 or a control command for releasing the safety catch on the firearm 18.

Control commands can be stored permanently in the cellular phone 2 in order to be read out and embedded into a radio signal on demand (in response to a user input). Control commands can also be stored temporarily, for example, for a predetermined period of time (e.g. for a predetermined duration when visiting a shooting range) in order to engage and release the safety catch on a firearm during this period.

Control commands may be provided to the cellular phone 2, for example, via a wired connection (e.g. via a data port of the cellular phone) established with the cellular phone 2 and/or via a wireless connection (e.g. via Bluetooth, infrared) and/or using a message (e.g. in form of an SMS, MMS, e-mail, etc.) transmitted to the cellular phone 2 via the mobile communications network. For example, the cellular phone 2 can be provided with control command(s) for engaging and/or releasing the safety catch on a firearm upon entering a shooting range, which control command(s) is/are valid for the period of time spent in the shooting range and can be used for controlling the firearm.

In the example shown in FIG. 2, the cellular phone 2 generates a radio signal comprising the corresponding control command when the safety catch on the firearm 18 is to be released or engaged and sends this radio signal directly, i.e. not via the mobile communications network, to the firearm 18. A receiver 14, which is capable of receiving radio signals of the cellular phone within the predetermined frequency range, is associated with the firearm 18.

The receiver 14 can be integrated into the firearm 18 or can be arranged at a position remote from the firearm 18; in FIG. 2, this is illustrated by the various receivers 6, of which individual ones or a plurality can be provided. The use of a plurality of receivers is better suited to ensure that the control command is received, for example, in order to avoid transmission problems due to interferences caused by other radio signals and/or unfavorable positioning of the cellular phone.

A wireless and/or wired connection between the receiver 14 and the firearm 18 or the control thereof (not shown) is provided. The received radio signal is evaluated, processed and the like by the receiver 14 or a device associated therewith in order to retrieve the control command. The extracted control command can then be provided to the firearm 18 or the control thereof directly without further processing or after processing, for example, for obtaining control data and/or information which readily control the firearm 18.

A transmitter 16 can also be associated with the firearm 18 which can be arranged on the firearm 18 or at a position remote therefrom; in FIG. 2, this is illustrated by the various transmitters 16, of which individual ones or a plurality can be provided. The use of a plurality of transmitters is better suited to avoid, for example, transmission problems between the transmitter 16 and the cellular phone 2 due to interferences caused by other radio signals and/or unfavorable positioning of the cellular phone.

A wireless and/or wired connection between the transmitter 16 and the firearm 18 or the control thereof (not shown) is provided.

The cellular phone 2 can be informed by the transmitter(s) 16 that the control command has been properly received and implemented, in this case in particular, that the safety catch on the firearm 18 has been engaged and/or released. Such a feedback can be implemented by means of a radio signal transmitted directly from the transmitter 16 to the cellular phone 2 without making a detour via the mobile communications network. On principle, a radio signal provided for this purpose is comparable to the radio signal comprising a control command transmitted by the cellular phone 2; however, said radio signal does not comprise a control command but the feedback to the cellular phone 2. Radio signals compliant with the mobile communications standard and/or audio signals can be employed.

Receiver 14 and transmitter 16 can be provided as a unit, as shown in FIG. 1, or as separate devices as not shown.

In the above examples explained with reference to FIGS. 1 and 2, an audio signal can be used instead of a radio signal which is transmitted by means of the loudspeaker of the cellular phone 2 to the respective transmitter which is configured accordingly in order to receive the audio signal. Apart from that, the above explanations apply accordingly to the case of audio signals.

### LIST OF REFERENCE NUMERALS

2 Cellular phone
4 Door
6 Door lock
8 Mobile communications network
10 Base station
12 Cellular phone
14 Receiver for the door lock 6
16 Transmitter for the door lock 6
18 Firearm

1. A cellular phone for the remote control of a device to be controlled, wherein the cellular phone is adapted to:
communicate according to a predetermined mobile communications standard in a mobile communications network operating in accordance with the predetermined mobile communications standard,
generate an output signal in form of a radio signal comprising at least one control command for the device to be controlled, and
transmit the radio signal within a frequency range provided for the mobile communications network directly to a receiver associated with the device to be controlled.

2. A cellular phone according to claim 1, which is adapted to generate the radio signal in form of a radio signal not compliant with the mobile communications standard.

3. A cellular phone according to claim 1, comprising hardware and/or software implemented functionality for generating the radio signal not compliant with the mobile communications standard.

4. A cellular phone for the remote control of a device to be controlled, wherein the cellular phone:
is adapted to communicate according to a predetermined mobile communications standard in a mobile communications network operating in accordance with the predetermined mobile communications standard, and
comprises an audio signal generating and outputting device which is adapted to generate an output signal in form of an audio signal comprising at least one control command for the device to be controlled and to output said signal to a receiver associated with the device to be controlled.

5. A receiver for a device which can be controlled by remote control, wherein remote control is provided by means of a cellular phone which is adapted to communicate according to a predetermined mobile communications standard in a mobile communications network operating in accordance with the predetermined mobile communications standard, and to generate an output signal in form of a radio signal within a predetermined frequency range provided for the mobile communications network, said radio signal comprising at least one control command for the device to be controlled, wherein the receiver is adapted to receive the radio signal directly and to provide the device to be controlled with the at least one control command.

6. A receiver according to claim 5, wherein the radio signal is a radio signal not compliant with the mobile communications standard.

7. A receiver for a device which can be controlled by remote control, wherein remote control is provided by means of a cellular phone which is adapted to communicate according to a predetermined mobile communications standard in a mobile communications network operating in accordance with the predetermined mobile communications standard, and to generate and transmit an output signal in form of an audio signal, said audio signal comprising at least one control command for the device to be controlled, wherein the receiver is adapted to receive the audio signal and to provide the device to be controlled with the at least one control command.

8. A system for the remote control of a device to be controlled, comprising:
a device to be controlled,
a receiver according to claim 5 associated with the device to be controlled, and
a cellular phone.

9. A method for the remote control of a device to be controlled by means of a cellular phone, which is adapted to communicate according to a predetermined mobile communications standard in a mobile communications network operating in accordance with the predetermined mobile communications standard, said method comprising the steps of generating an output signal in form of a radio signal, which comprises at least one control command for the device to be controlled, and transmitting the radio signal within a frequency range provided for the mobile communications network directly to a receiver associated with the device to be controlled by means of said cellular phone.

10. A method for the remote control of a device to be controlled by means of a cellular phone, which is adapted to communicate according to a predetermined mobile communications standard in a mobile communications network operating in accordance with the predetermined mobile communications standard, and which comprises an audio signal generating and outputting device, said method comprising the steps of generating an output signal in form of an audio signal, which comprises at least one control command for the device to be controlled, and outputting said signal to a receiver associated with the device to be controlled by means of said cellular phone.
in a shot in at least one special area.
